(19) United States
(12) Patent Application Publication
(10) Pub. No.: US 2026/0193026 A1
(43) Pub. Date: Jul. 9, 2026

(54) LOCKING DEVICE FOR RESIDENTIAL DUMPSTER AND METHODS

(71) Applicant: Serio-Us Industries, Inc., Baltimore, MD (US)

(72) Inventors: David L. REEB, Sykesville, MD (US); James L. MARTIN, II, Gambrills, MD (US)

(21) Appl. No.: 19/425,031

(22) Filed: Dec. 18, 2025

Related U.S. Application Data
(60) Provisional application No. 63/735,674, filed on Dec. 18, 2024.

(51) Int. Cl. B65F 1/16

(52) U.S. Cl. CPC B65F 1/1615; B65F 2210/1443; B65F 2210/148; B65F 2210/168

(57) ABSTRACT

A locking device for a residential dumpster having a container body and a hinged lid. The locking device comprises a base lock unit mounted to the lid, a lock actuator mechanism and a base member secured the container body and disposed adjacent to the lock actuator mechanism. The base member includes a hollow base plate formed with a locking groove, and a pawl. The pawl is pivotable between a closed position and an open position wherein the pawl hook stands out of the locking groove. The lock actuator mechanism includes a pivotable latch lever, a cam shaft extending through the locking groove, a locking cam non-moveably attached to the cam shaft so as to extend though the groove in the base plate, a pivot lever and a support member fixed to the pivot lever such that a distal end of the latch lever is configured to engage the support member.

### CROSS REFERENCE TO RELATED APPLICATIONS

This application claims the benefit of priority of U.S. Provisional Patent Application Ser. No. 63/735,674 filed on Dec. 18, 2024, by David L. Reeb and James L. Martin, II, which is hereby incorporated herein by reference in its entirety and to which priority is claimed.

### BACKGROUND OF INVENTION

### Field of the Invention

The present invention generally relates to locking devices for waste containers (or dumpsters) and methods of use of the locking devices, particularly residential dumpsters. In particular, the invention relates to a locking device for a residential dumpster for securing and locking a closed lid of the dumpster and methods of use which keeps the residential dumpster closed in the event of a sudden jerk or jarring, such as caused by ground impact. The invention allows the lid to open automatically when the waste container is tipped over by a dumping operation. The locking device prevents unauthorized access to the container while still allowing access by a refuse company to empty the container without the driver manually unlocking the lock. Additionally, the owner may access the container through a key.

### Background of the Invention

As is well known, residential or commercial waste containers, for use in residential or commercial applications, typically include a base structure covered by a pivotable lid. These containers usually comprise a block-shaped container with a hinged lid attached to one side thereof. The containers may be emptied by an automated lifting device on certain waste removal vehicles, which tilt the waste containers for emptying the contents. The containers are generally lifted by the lifting mechanism and pivoted in some fashion, so that the hinged top of the container opens and the trash contained therein is emptied into the vehicle. The container is then returned to a position on the ground, and the hinged lid closes due to gravity on the top of the container.

The waste containers may be available for purchase by homeowners from various home improvement big box retailers and department stores. When the container is in an upright position, the lid is closed and prevents animals from accessing the waste within the container. However, when the container is tipped over on its side, e.g., by animals or by strong wind, the lid may open, spilling the contents of the container or allowing animals to access the interior of the container.

Locks may be provided to prevent the lid from opening when the waste container is knocked over on its side or to prevent unwanted access to the container. However, these locks may prevent the automated lifting device on the trash removal vehicle from being able to empty the container, or require the operator to manually unlock the waste container before placing it on the automated lifting device.

Therefore, there remains a need for a locking device that prevents the unintended opening of the waste container, such as by an accidental knockdown, but does not require manual unlocking when being tilted over, e.g., by a lifting mechanism.

### SUMMARY OF THE INVENTION

According to a first aspect of the invention, there is provided a locking device for a residential dumpster having a container body and a hinged lid pivotally connected to the container body. The locking device comprises a base lock unit adapted to be mounted to the lid and including a casing having a front panel, and a lock actuator mechanism disposed within the casing; and a base member adapted to be secured to an inner surface of the container body and disposed adjacent to the front panel of the casing. The base member includes a hollow base plate formed with a U-shaped locking groove at a top edge thereof, and includes therewithin a pawl formed with a pawl hook. The pawl is pivotable between a closed position wherein the pawl hook protrudes into the locking groove of the base plate and an open position wherein the pawl hook stands out of the locking groove. The pawl is biased toward the closed position thereof. The lock actuator mechanism includes a latch lever pivotally disposed within the casing, a cam shaft extending through the front panel and though the locking groove of the base plate, a locking cam non-moveably attached to the cam shaft so as to extend though the locking groove in the base plate, a pivot lever pivotable relative to the casing, and a support member fixed to the pivot lever such that a distal end of the latch lever is configured to engage the support member. The cam shaft is rotatable relative to the front panel of the casing and the base plate. The latch lever is non-rotatably attached to the cam shaft and pivotally mounted to the front panel of the casing. The locking cam is pivotally movable between a locked position preventing the movement of the locking cam out of the locking groove so as to prevent relative movement between the casing of the base lock unit and the base plate, and a release position permitting the movement of the locking cam out of the locking groove so as to permit relative movement between the casing of the base lock unit and the base plate.

According to a second aspect of the invention, a residential dumpster is provided, which is liftable and tippable over by a dumping vehicle between an upright position and a tilted position sufficient to enable at least some of the contents of the container to be dumped therefrom. The residential dumpster comprises a container body, a hinged lid pivotally mounted to the container body and moveable between a closed position when the container is in the upright position and an open position when the container is in the tilted position, and a locking device. The locking device comprises a base lock unit mounted to the lid and including a casing having a front panel, and a lock actuator mechanism disposed within the casing; and a base member secured to an inner surface of the container body and disposed adjacent to the front panel of the casing. The base member includes a hollow base plate formed with a U-shaped locking groove at a top edge thereof, and further includes therewithin a pawl formed with a pawl hook. The pawl is pivotable between a closed position wherein the pawl hook protrudes into the locking groove of the base plate and an open position wherein the pawl hook stands out of the locking groove. The pawl is biased toward the closed position thereof. The lock actuator mechanism includes a latch lever pivotally disposed within the casing, a cam shaft extending through the front panel and though the locking groove of the base plate, and rotatable relative to the front panel of the casing and the base plate, a locking cam non-moveably attached to the cam shaft so as to extend though the locking groove in the base plate, a pivot lever pivotable relative to the casing, and a support member fixed to the pivot lever such that a distal end of the latch lever is configured to engage the support member. The latch lever is non-rotatably attached to the cam shaft and pivotally mounted to the front panel of the casing. The locking cam is pivotally movable between a locked position preventing the movement of the locking cam out of the locking groove so as to prevent relative movement between the casing of the base lock unit and the base plate, and a release position permitting the movement of the locking cam out of the locking groove so as to permit relative movement between the casing of the base lock unit and the base plate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Other aspects of the invention, including apparatus, devices, systems, converters, processes, and the like which constitute part of the invention, will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. These same numbers are used throughout the figures to reference like figures and components. In such drawings:

FIG. 1 is a front perspective view of a residential dumpster according to an exemplary embodiment of the invention;

FIG. 2 is a side partial sectional view of the residential dumpster of FIG. 1;

FIG. 3A is a front perspective view of a locking device according to the exemplary embodiment of the invention;

FIG. 3B is a rear perspective view of the locking device according to the exemplary embodiment of the invention;

FIG. 4 is an enlarged front perspective view of the locking device of FIG. 3A;

FIG. 5 is a perspective view of a base plate and a base lock unit according to the exemplary embodiment of the invention in a locked state;

FIG. 6 is a perspective view of the base plate in an open state and a front panel of the casing according to the exemplary embodiment of the invention when the cam of the base lock unit is horizontally oriented and disposed away from the groove of the base plate;

FIG. 7A is a perspective view from the left of the base lock unit according to the exemplary embodiment when the residential dumpster is in an upright position;

FIG. 7B is a perspective view from the right of the base lock unit according to the exemplary embodiment when the residential dumpster is in an upright position;

FIG. 8A is a perspective view from the right of the base lock unit according to the exemplary embodiment when the base lock unit is in a locked position;

FIG. 8B is a front perspective view of the base lock unit according to the exemplary embodiment when the base lock unit is in the locked position;

FIG. 9 is a perspective view of the base lock unit according to the exemplary embodiment when the residential dumpster is tipped over sideways by an animal and forcefully hits the ground while the pivot lever of the base lock unit is in a rest position;

FIG. 10 is a perspective view of the base lock unit according to the exemplary embodiment when the residential dumpster is tipped over sideways by an animal and forcefully hits the ground while the pivot lever of the base lock unit is away from the rest position;

FIG. 11 is a perspective view of the base lock unit according to the exemplary embodiment when the residential dumpster is picked up by a truck and tipped over by the truck so that the pivot lever is away from the rest position;

FIG. 12 is a perspective view of the base lock unit according to the exemplary embodiment when the residential dumpster is picked up by the truck and tipped by the truck so that the pivot lever is away from the rest position and a latch lever disengaged from the pivot lever;

FIG. 13 is a front perspective view of the base lock unit according to the exemplary embodiment when the locking cam is in a release position when the locking cam of the base lock unit is inclined within a groove of the base plate while the residential dumpster is closed;

FIG. 14 is a front perspective view of the base lock unit according to the exemplary embodiment when the locking cam of the base lock unit in the release position is inclined and begins to exit the groove of the base plate;

FIG. 15 is a front perspective view of the base lock unit according to the exemplary embodiment when the cam of the base lock unit is horizontally oriented and disposed away from a bottom of the groove of the base plate wherein the pawl is moved inside the base plate;

FIG. 16 is a front perspective view of the base lock unit according to the exemplary embodiment in the locked state when the cam of the base lock unit is horizontally oriented and disposed in the groove of the base plate and the residential dumpster is closed;

FIG. 17 is a rear perspective view of a locking device according to an alternative exemplary embodiment of the invention;

FIG. 18 is the rear perspective view of the locking device according to the alternative exemplary embodiment with removed battery cover;

FIG. 19A is a perspective view from the right of a base lock unit according to the alternative exemplary embodiment with the residential dumpster in a locked and upright position;

FIG. 19B is a perspective view from the right of the base lock unit according to the alternative exemplary embodiment with the residential dumpster in a locked and tilted position;

FIG. 20A is a rear view of the base lock unit according to the alternative exemplary embodiment with the residential dumpster in a locked position;

FIG. 20B is a perspective view of the base lock unit according to the alternative exemplary embodiment with released latch lever; and

FIG. 21 is a rear perspective view of the base lock unit according to the alternative exemplary embodiment with the residential dumpster in an unlocked and upright position.

### DETAILED DESCRIPTION

References will now be made in detail to exemplary embodiments and methods of the invention as illustrated in the accompanying drawings, in which the like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal”, “vertical”, “front”, “rear” or “back”, “upper”, “lower”, “upright”, “side”, “top”, “bottom”, “right”, “left” or the like as well as derivatives thereof (e.g., “horizontally”, “downwardly”, “upwardly”, etc.) designate directions in the drawings to which reference is made and are relative characterizations only based upon the particular position or orientation of a given component as illustrated. These terms shall not be regarded as limiting the invention. The words “downward” and “upward” refer to position in a vertical direction relative to a geometric center of the apparatus of the present invention and designated parts thereof. The terminology includes the words above specifically mentioned, derivatives thereof and words of similar import.

These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixedly (i.e., non-moveably) connected together. The words “smaller” and “larger” refer to relative size of elements of the apparatus of the present invention and designated portions thereof. Additionally, the word “a” and “an” as used in the claims means “at least one” and the word “two” as used in the claims means “at least two”.

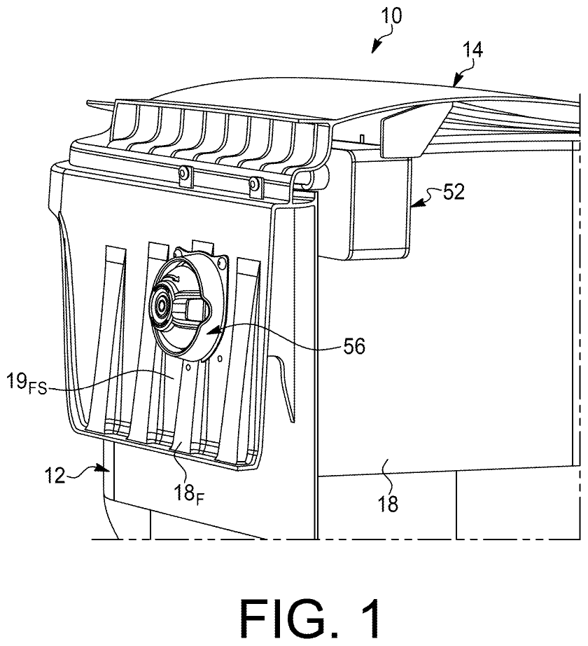

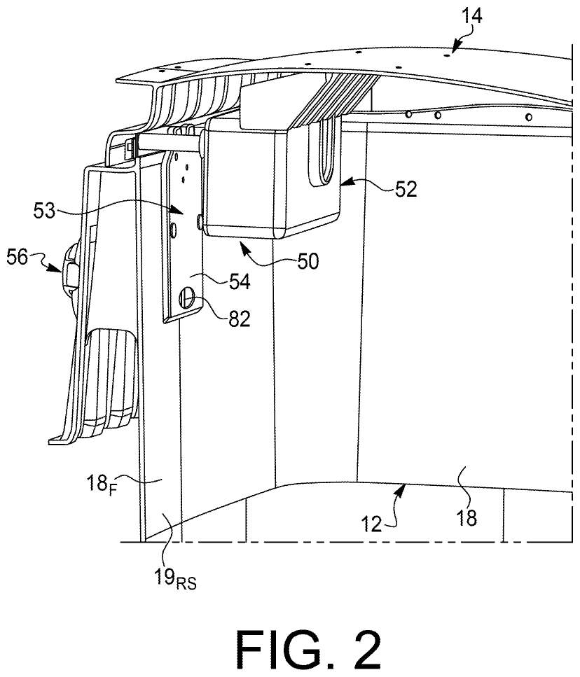

FIGS. 1 and 2 depict a waste container 10, such as a trash container or a residential dumpster, sometimes called a tote, according to an exemplary embodiment. The residential dumpster 10 is used by homeowners or businesses to deposit, retain, or store trash awaiting pick-up by a trash removal vehicle. The residential dumpster 10 may be tilted or otherwise pivoted from an upright storage position (as shown in FIG. 1) to a tilted or dumping position to empty its contents.

The residential dumpster 10 has a container body 12 and a lid 14 pivotally mounted on top of the container body 12. The container body 12 defines an interior volume for holding waste. The lid 14 is pivotally mounted on a lid hinge, typically at the rear of the container body 12 so that when an upward force is applied to the lid 14, it opens by pivoting on the lid hinge 16. The container body 12 includes a plurality of side walls 18, typically four sidewalls 18. Alternatively, the container body 12 and the lid 14 may be round in shape. The lid 14 and the container body 12 of the residential dumpster 10 may be made of the same or different materials, and typically are plastic.

The residential dumpster 10 has a locking device 50 comprising a base lock unit 52 mounted to the lid 14, a base member 53 and a lock operator 56, both secured to a front side wall 18_{F} of the container body 12. Specifically, as shown in FIGS. 1 and 2, the lock operator 56 is mounted to a front (or outer) surface 18_{FS} of the front side wall 18_{F} of the container body 12 (i.e., outside the container body 12), while the base plate 54 is mounted to a rear (or inner) surface 18_{RS} of the front side wall 18_{F} of the container body 12 (i.e., within the container body 12). According to the exemplary embodiment, the base lock unit 52 is positioned towards the front of the lid 14.

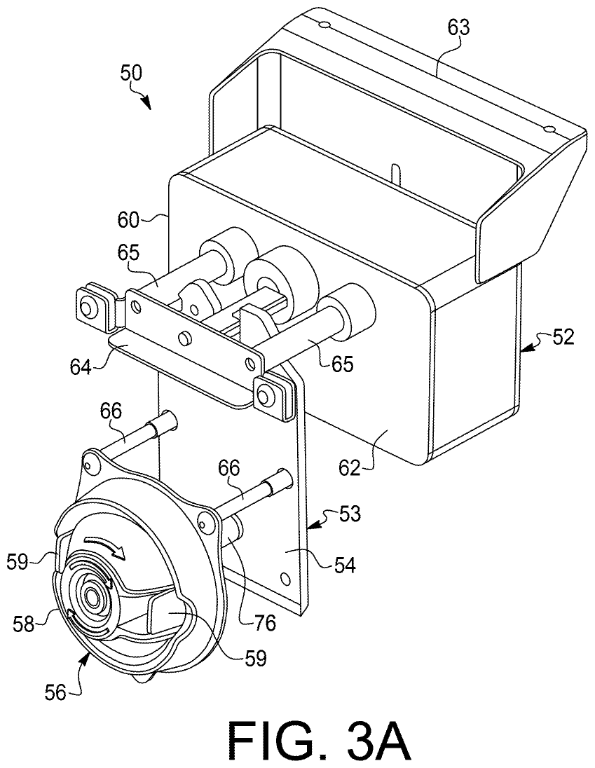

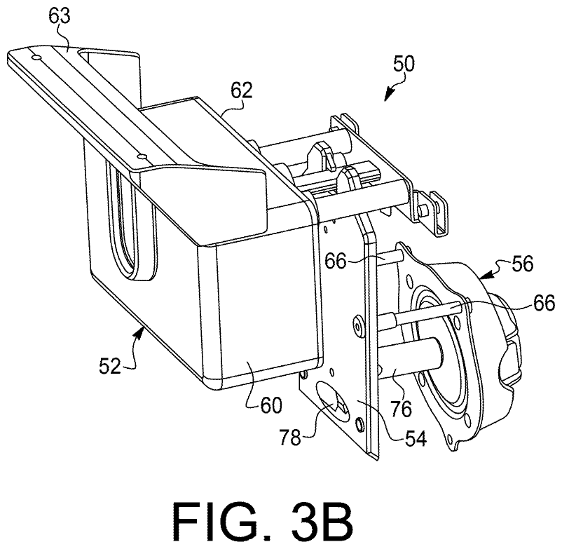

The base lock unit 52 includes a casing 60 mounted to the lid 14 of the residential dumpster 10 via a top connector plate 63 and a front connector plate 64. The lock operator 56 includes a manual rotary knob 58 and a pair of opposed detent members 59, and the rotary knob 58 is manually rotatable only when a user manually depresses the detent members 59. The lock operator 56 is connected to the base member 53 via mounting fasteners, such as screws 66 and/or bolts. The lock operator 56 further includes a key-operated cylinder lock 76 extending between the rotary knob 58 and the base plate 54, as best shown in FIGS. 3A, 3B, 5 and 6.

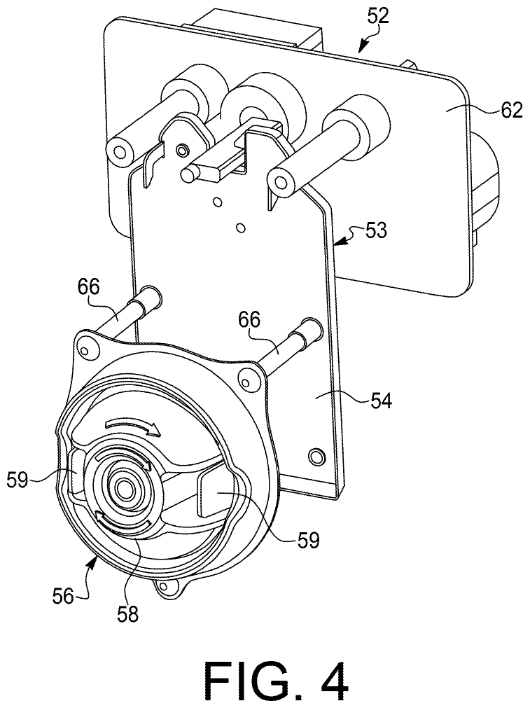

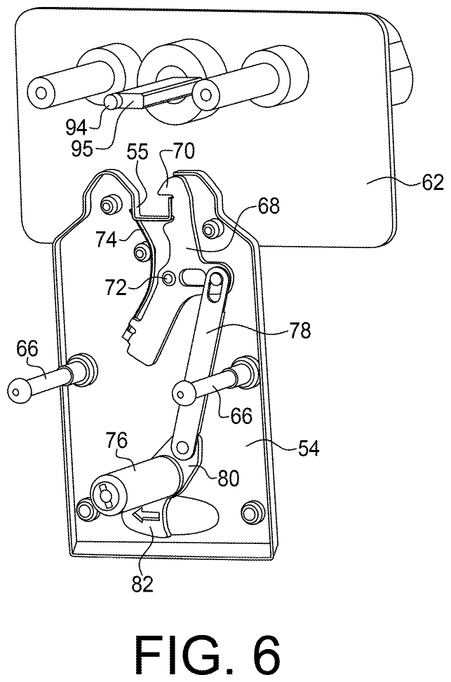

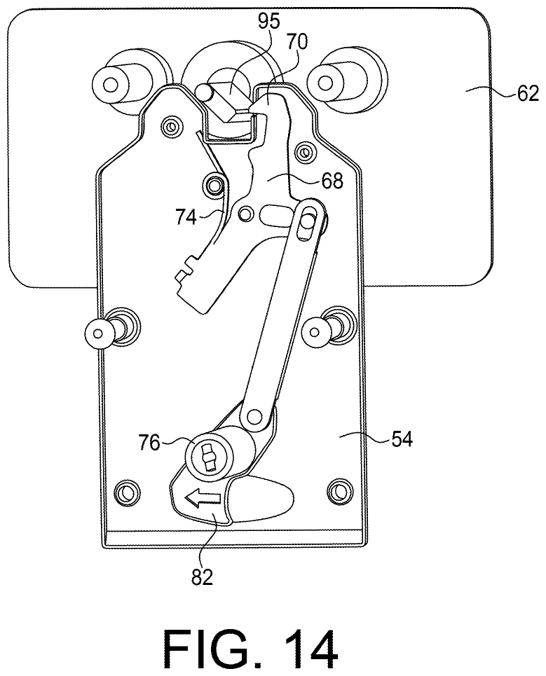

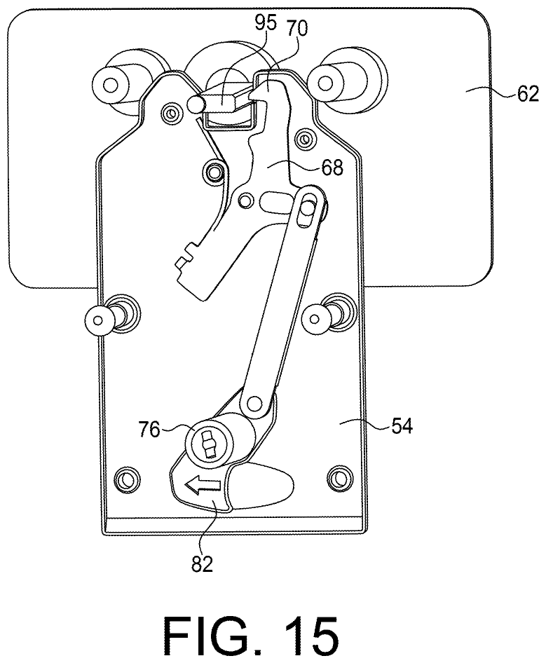

Also, as shown in FIGS. 3A-4, the base member 53 is disposed between the lock operator 56 and a front panel 62 of the casing 60. The base member 53 comprises a hollow base plate 54 is formed with a U-shaped locking groove 55 at a top edge thereof. Moreover, disposed within the hollow base plate 54, there is a pawl 68 formed with a pawl hook 70. The pawl 68 is pivotable about a pivot shaft 72 between a closed position, wherein the pawl hook 70 protrudes into the locking groove 55 of the base plate 54 as shown in FIGS. 4-6, 8A, 8B, 13 and 16, and an open position, wherein the pawl hook 70 stands out of the locking groove 55, as shown in FIGS. 14-15. The pawl 68 further comprises a pawl biasing spring 74 biasing the pawl 68 toward the closed position thereof so that the pawl hook 70 extends (or protrudes) into the U-shaped locking groove 55 of the base plate 54. According to the exemplary embodiment, the pawl biasing spring 74 is a torsion spring, as best shown in FIG. 6. As further shown in FIG. 6, the pivot shaft 72 is mounted to the base plate 54.

Furthermore, within the hollow base plate 54, there are a first link 78 moveably connected to the pawl 68, and a second link 80 secured to the cylinder lock 76 at one end thereof and rotatably connected to the first link 78 at an opposite end of the second link 80. Rotation of a key (not shown) in the cylinder lock 76 rotates the second link 80 clockwise (as shown in FIG. 6), which moves the first link 78 downward, which, in turn, pivots the pawl 68 clockwise about the pivot shaft 72. As a result, the pawl hook 70 withdraws into the base plate 54 and out of the locking groove 55.

The base plate 54 is further provided with a manual latch actuator 82 for actuating (pivoting) the pawl 68 from inside of the container body 12. Upon pressing a manual latch button in the direction of an arrow marked thereupon, pawl 68 withdraws the pawl hook 70 into the base plate 54 and out of the locking groove 55 via the first and second links 78 and 80 much like the key-operated cylinder lock 76, as best shown in FIG. 6.

The base lock unit 52 further includes a lock actuator mechanism 83 disposed within the casing 60. The lock actuator mechanism 83 comprises a pivot lever 84 pivotable about a pivot axle 85 secured to the casing 60, a curved guide track 90 secured to the front panel 62 of the casing 60, a latch lever 92, and a pivot lever limiter 100 for controlling the pivotal movement of the pivot lever 84 and acting as a tip-over sensor configured to determine whether the residential dumpster 10 being tipped for dumping or knocked over.

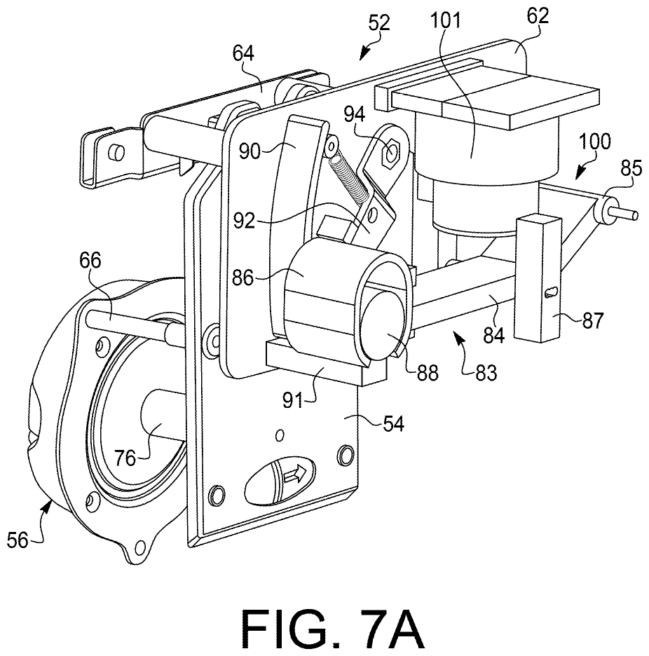

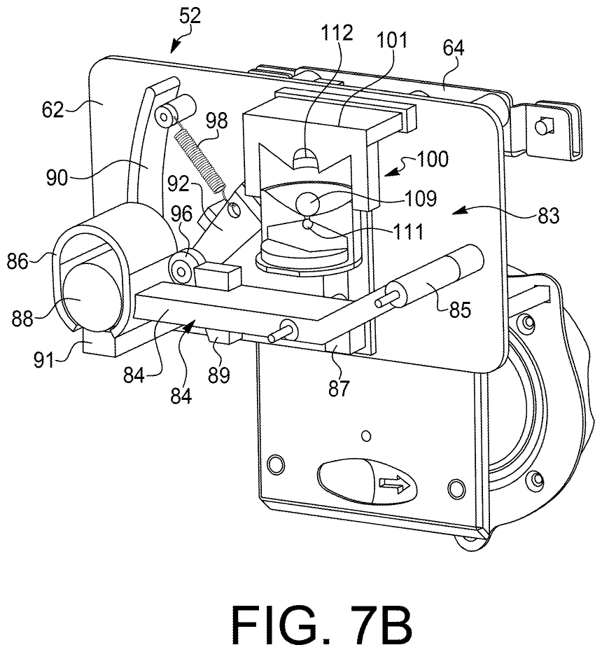

The pivot lever 84 is pivotable about the pivot axle 85, while a hollow oval casing 86 is attached to an opposite end of the pivot lever 84. As best shown in FIGS. 7A and 7B, a weight 88, in the form of a metal cylinder or a metal ball, is disposed inside the hollow oval casing 86 and is moveable within the hollow oval casing 86 by gravity. Also, a pair of sliders 87 are rotatably mounted to the pivot lever 84. The lock actuator mechanism 83 also comprises a support bar 91 non-moveably secured to the casing 60 for limiting downward movement of the pivot lever 84. The pivot lever 84 contacts the support bar 91 when the pivot lever 84 is in a rest position.

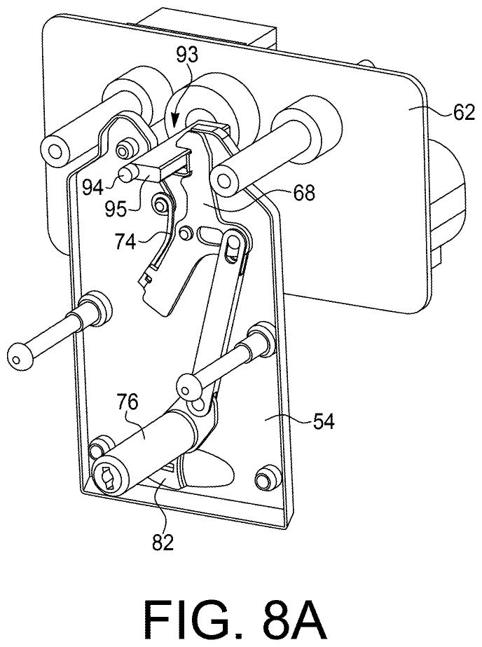

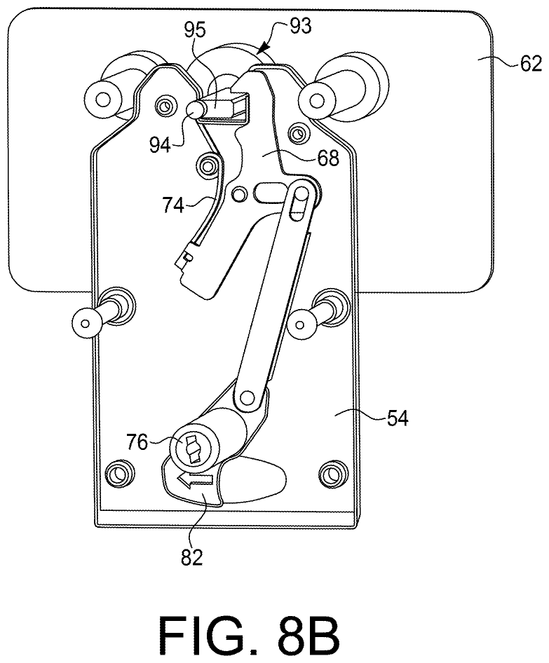

The lock actuator mechanism 83 further comprises a cam shaft 94 extending through the front panel 62 and though the base plate 54, and a locking cam 95 disposed outside the casing 60 and non-moveably attached (i.e., fixed) to the cam shaft 94. A proximal end of the latch lever 92 is pivotally mounted to the front panel 62 of the casing 60 by the cam shaft 94. The cam shaft 94 is non-rotatably attached to the latch lever 92, as best shown in FIG. 7A. The locking cam 95 is non-moveably attached to the cam shaft 94 so as to extend through the locking groove 55 in the base plate 54, as best shown in FIGS. 8A and 8B. The locking groove 55 in the base plate 54, the pawl 68 with the pawl hook 70, and the locking cam 95 together define a latch mechanism 93.

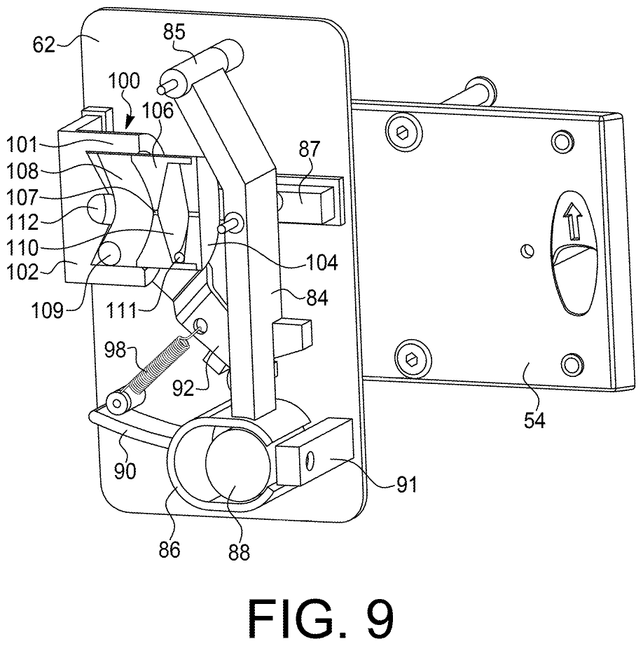

Furthermore, a distal end of the latch lever 92 has a support wheel (or bearing, such as roller bearing) 96 configured to engage a support member 89, which is fixed to the pivot lever 84, when the locking cam 95 is in the locking groove 55 of the base plate 54, as shown, inter alia, in FIGS. 7B and 9. The latch lever 92 is biased by biasing spring 98 against the support member 89.

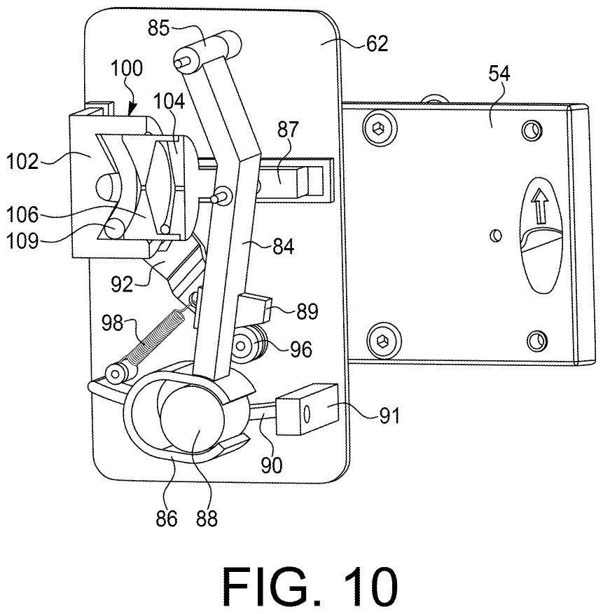

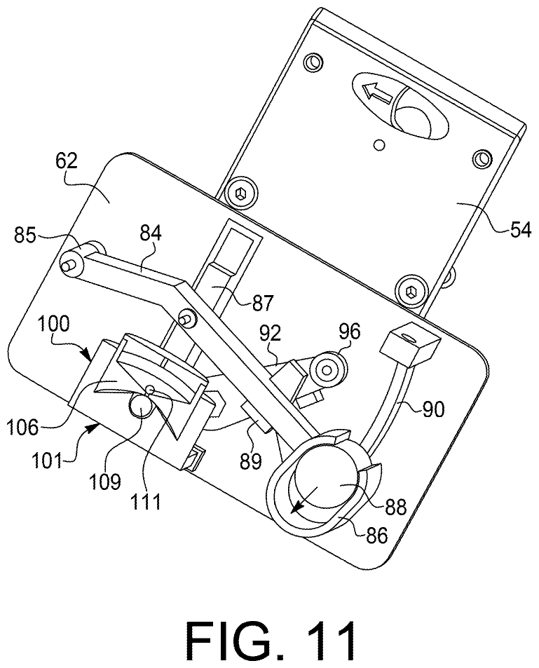

The pivot lever limiter 100 comprises a housing 101 forming a first chamber 108 and a second chamber 110, wherein the first chamber 108 contains a first ball 109, while the second chamber 110 contains a second ball 111, as best shown in FIG. 11. Thus, the first ball 109 is allowed to roll around the first chamber 108, while the second ball 111 is allowed to roll around the second chamber 110. According to the exemplary embodiment, the housing 101 includes a top cylindrical member 102 and a bottom cylindrical member 104 separated by circular separation member 106 having axially opposite concave surfaces. In turn, the top cylindrical member 102 has a convex surface facing the separation member 106, while the bottom cylindrical member 104 has a concave surface facing the separation member 106. The separation member 106 has a central through-aperture connecting the first chamber 108 with the second chamber 110. Moreover, the top cylindrical member 102 is non-moveably secured to the casing 60, while the bottom cylindrical member 104 with the circular separation member 106 are fixed to one another and both are moveable relative to the top cylindrical member 102, as shown in FIGS. 9 and 10. Furthermore, the top cylindrical member 102 has a central cavity 112 complementary to the first ball 109.

One of the balls 109 and 111 is magnetic while the other is made of ferromagnetic material. According to the exemplary embodiment, the smaller second ball 111 is magnetic, while the first ball 109 is a steel ball. The first and second balls 109, 111 are only connected through magnetic attraction when in the middle of the separation member 106 and adjacent each other. They are magnetically attracted to each other, as shown in FIG. 7B, so that when the base lock unit 52 is gently tipped over upside down, the balls 109,111 remain connected and nothing happens. The first ball 109 stays in the location because it is attached magnetically to the second ball 111. The balls 109, 111 are attached to each other and the normal state is to stay that way (i.e., magnetically attached to each other), no matter the orientation of the base lock unit 52 as long as the dumpster 10 is tipped gently, such as when the dumpster 10 is picked up by a truck and tipped over for emptying.

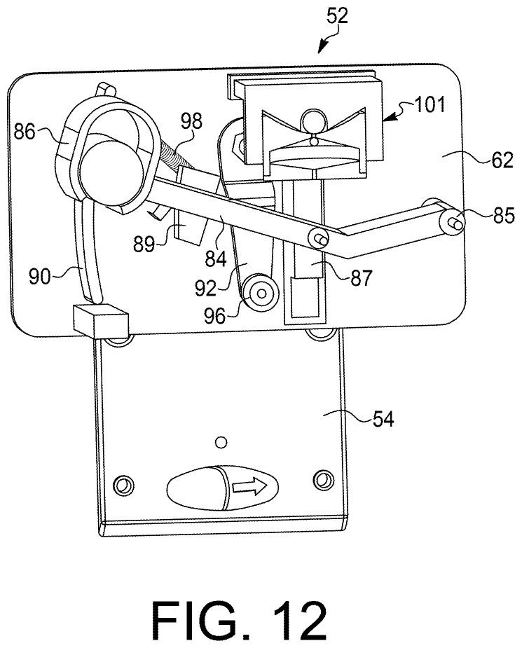

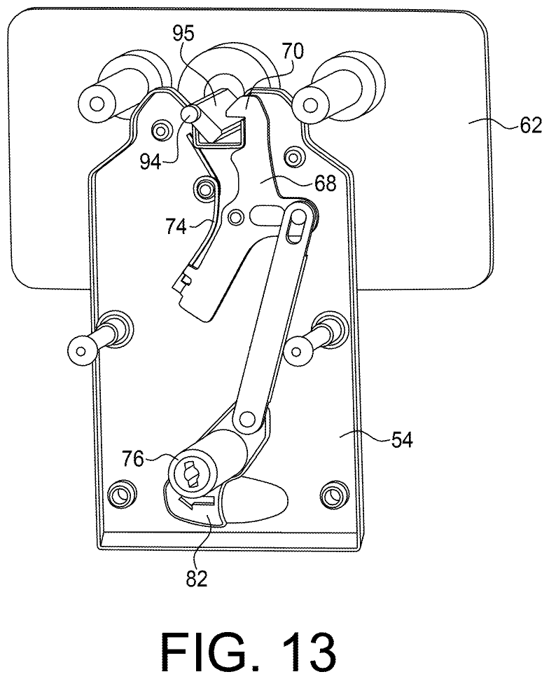

The balls 109, 111 remain attached to each other and when the residential dumpster 10 is turned completely upside down, the weight of the pivot lever 84 with the weight 88 has a bias to fall along the guide track 90, as shown in FIGS. 10-12. When the residential dumpster 10 is upside down, the pivot lever 84 pivots down and falls into the position shown in FIGS. 11 and 12. When the residential dumpster 10 is tipped more than 90°, and because the balls 109 and 111 are magnetically attracted to each other, the pivot lever 84 begins moving further along the guide track 90 and the pivot lever 84 pushes the bottom member 104 and the separation member 106 toward the top member 102. Eventually the separation member 106 engages the top member 102, as shown in FIGS. 11 and 12. As a result, the support wheel 96 of the latch lever 92 is disengaged from the support member 89 of the pivot lever 84. As a consequence, the locking cam 95 on the cam shaft 94 rotates counterclockwise, as shown in FIGS. 13 and 14, thus allowing the lid 14 to be open by gravity as shown in FIG. 6.

Also, the lid 14 of the residential dumpster 10 may be manually opened by key-operated cylinder lock 76 configured to withdraw the pawl hook 70 of the pawl 68 into the hollow base plate 54 and out of the locking groove 55, as shown in FIG. 15, thus opening the residential dumpster 10.

However, when the residential dumpster 10 is tipped over roughly, such as by an animal, and forcefully hits the ground while the pivot lever 84 of the base lock unit 52 is in the rest position, i.e., engages the support bar 91 (as shown in FIG. 9), the balls 109 and 111 disconnect from each other and fall down into the chambers 108 and 110, respectively, as shown in FIG. 9. Upon further tipping of the residential dumpster 10, the pivot lever 84 begins moving along the guide track 90, the pivot lever 84 pushes the bottom member 104 and the separation member 106 toward the top member 102. However, eventually the separation member 106 engages the ball 109, which prevents the separation member 106 from moving further towards and engaging the top member 102, as shown in FIG. 10. As a result, the support wheel 96 of the latch lever 92 remains in contact with the support member 89 of the pivot lever 84, thus preventing counterclockwise movement of the latch lever 92. As a consequence, the residential dumpster 10 stays closed.

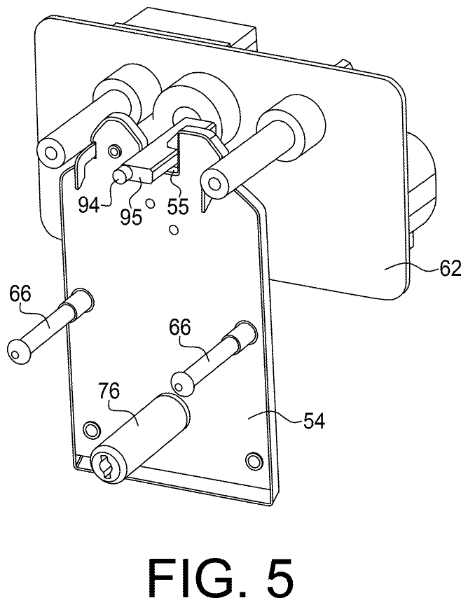

FIGS. 5, 8A, 8B and 16 illustrate the base lock unit 52 according to the exemplary embodiment in a locked position where the locking cam 95 of the base lock unit 52 is horizontally oriented within the locking groove 55 (i.e., disposed in the locking groove 55) of the base plate 54, so that the residential dumpster 10 remains closed. Specifically, the locking cam 95 in the locked position prevents the movement of the locking cam 95 out of the locking groove 55 so as to prevent relative movement between the casing 60 of the base lock unit 52 and the base plate 54, i.e., prevents pivotal movement of the hinged lid 14 relative the hinged lid 14.

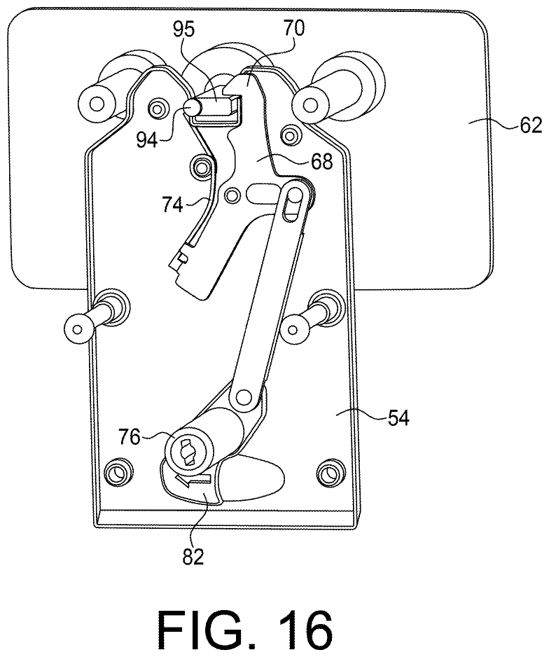

FIGS. 13 and 16 illustrate the base lock unit 52 according to the exemplary embodiment in a release position where the locking cam 95 of the base lock unit 52 is inclined within the locking groove 55 of the base plate 54 while the residential dumpster 10 is closed. Specifically, the locking cam 95 in the release position permits the movement of the locking cam 95 out of the locking groove 55 so as to permit relative movement between the casing 60 of the base lock unit 52 and the base plate 54, i.e., allows pivotal movement of the hinged lid 14 relative the hinged lid 14.

FIG. 14 is a front perspective view of the base lock unit according to the exemplary embodiment when the locking cam of the base lock unit in the release position is inclined and begins to exit the groove of the base plate.

FIG. 16 illustrates the base lock unit 52 according to the exemplary embodiment in the locked state where the cam 95 of the base lock unit 52 is horizontally oriented and disposed in the groove 55 of the base plate 54, so that the residential dumpster 10 remains closed.

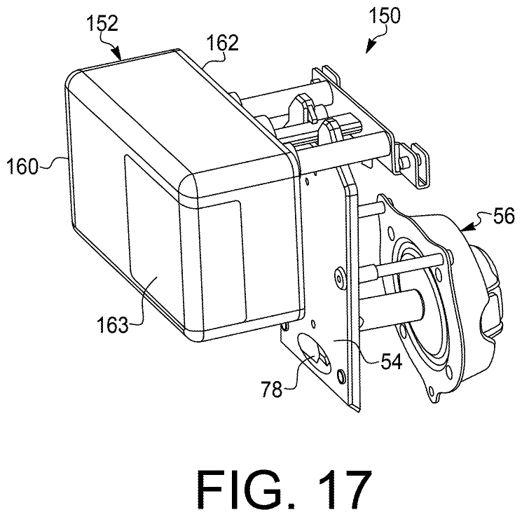

Locking device 150 of an alternative embodiment is illustrated in FIGS. 17-21, and the mechanically operated base lock unit 52 is replaced by an electronically operated base lock unit 152. The locking device 150 of FIGS. 17-21 corresponds substantially to the locking device 50 of FIGS. 1-16, and portions which differ will therefore be explained in greater detail below.

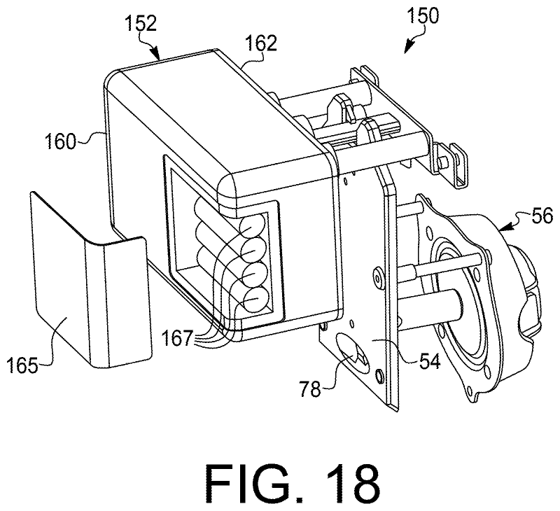

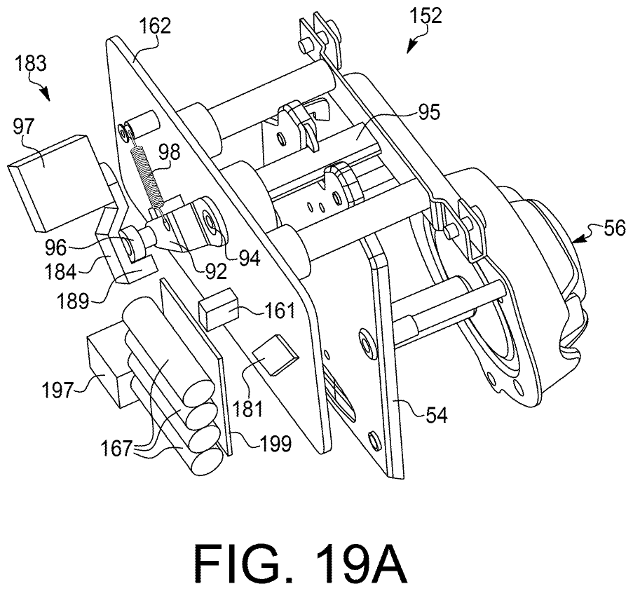

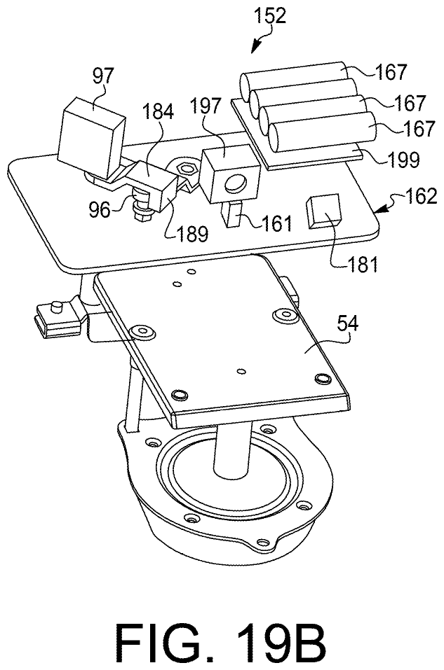

The base lock unit 152 includes a casing 160 mounted to the lid 14 of the residential dumpster 10. As best shown in FIGS. 17 and 18, the casing 160 includes a front panel 162 and a removable battery lid 165 providing access one or more electrical batteries 167, such as rechargeable batteries. The base lock unit 152 further includes an electrical lock actuator mechanism 183 disposed within the casing 160, best shown in FIGS. 19A and 19B. The lock actuator mechanism 183 comprises a pivot lever 184 pivotable about a pivot axle 85 secured to the casing 160, a latch lever 92, and a servomotor 97 configured to selectively rotate the pivot lever 184. Furthermore, as shown, in FIGS. 19A and 19B, a distal end of the latch lever 92 has a support wheel (or bearing, such as roller bearing) 96 configured to engage a support member 189, which is fixed to the pivot lever 184, when the locking cam 95 is in the locking groove 55 of the base plate 54. The latch lever 92 is biased by biasing spring 98. The lock actuator mechanism 183 also comprises a hard stop 161 for the latch lever 92.

The electronically operated lock actuator mechanism 183 further includes a tip-over sensor, such as an accelerometer 181, and a printed circuit board (PCB) 199 that includes a controller and is mounted between the electrical batteries 167 and the front panel 162 of the casing 160, as illustrated in FIGS. 19A-21 and a hard stop 161. The tip over sensor 181 is configured to determine whether the residential dumpster being tipped for dumping or knocked over. The lock actuator mechanism 183 may also include a camera 197 to sense accumulation of trash and other materials in container 10. Additionally, should the camera 197 sense that the container body 12 is filled, it may send a signal to the controller 199, which in turn may send a signal by Bluetooth, Wi-Fi, etc. to a hauler or user that the container body 10 is filled and needs to be dumped. The one or more electrical batteries 167 are electrically connected to the servomotor 97, the camera 197, the accelerometer 181 and the PCB 199. The controller 199 is operatively connected to the servomotor 97, the camera 197 and the accelerometer 181.

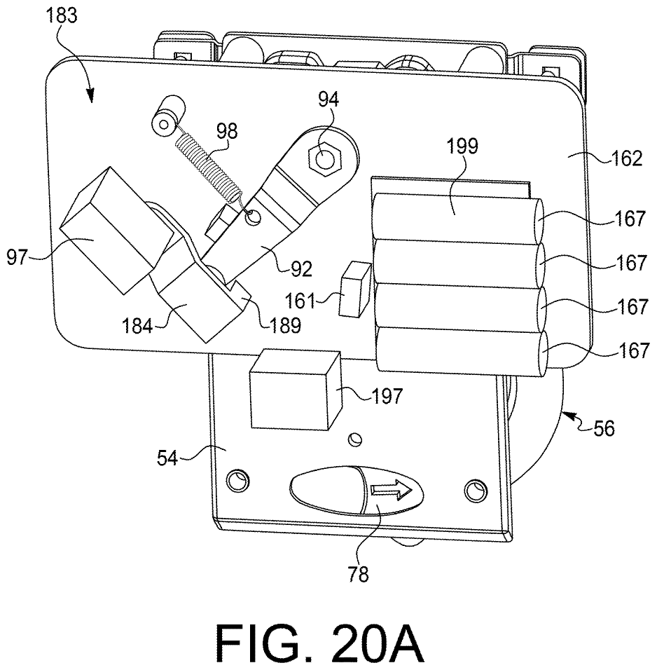

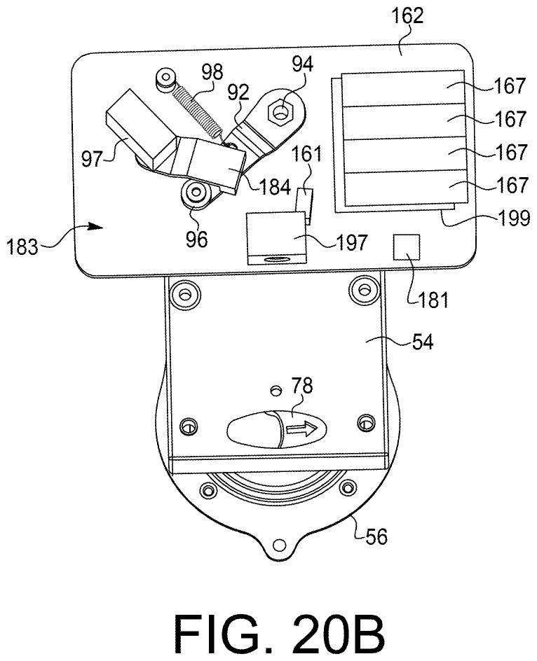

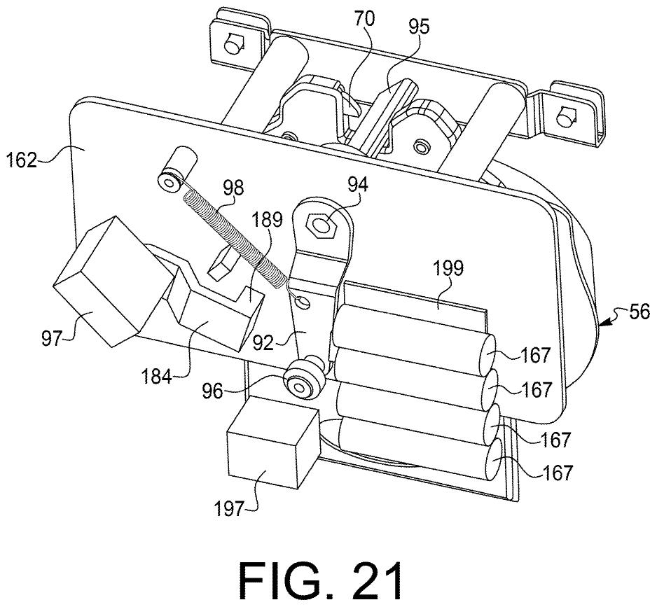

In use, the electronic lock actuator mechanism 183 operates essentially as did the mechanical lock operating mechanism 83 of FIGS. 1-16. Should the container 10 be slowly lifted up then tipped over, such as when being serviced by a hauler, then the accelerometer 181 senses this motion of the container 10 and signals the controller 199, which, in turn, actuates the servomotor 97. The servomotor 97 then rotates the pivot lever 184 and causes the pivot lever 184 to pivot out of engagement with the wheel 96, as shown in FIG. 20B. The latch lever 92 is then free to pivot about the cam shaft 94 so as to rotate the locking cam 95 in the locking groove 55 of the base plate 54 to the unlocked position, as shown in FIG. 21.

If, on the other hand, the container 10 falls (or tips) over, such as by a wild animal or wind, the accelerometer 181 senses the impact and does not signal the controller 199. Consequently, the controller 199 does not send a signal to servomotor 97, which does not rotate the pivot lever 184 to pivot out of engagement with wheel 96. The latch lever 92 is then not free to pivot about the cam shaft 94 so as to maintain the locking cam 95 in the locked position, and prevent the locking mechanism from moving into the unlocked position in which lid 14 remains closed and locked.

The electronic lock actuator mechanism 183 thus is a substitute for the mechanical lock actuator mechanism 83. The mechanical lock actuator mechanism and the electronic lock actuator mechanism both operate to determine whether the container 10 is being tipped for servicing and thus the lid 14 may be opened, and whether it falls over due to some other event and thus the lid 14 is to be maintained in the closed and locked position.

The foregoing description of the exemplary embodiments of the invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the invention be defined by the claims appended thereto.

What is claimed is:

1. A locking device for a residential dumpster having a container body and a hinged lid pivotally connected to the container body, the locking device comprising:
a base lock unit adapted to be mounted to the lid, the base lock unit including a casing having a front panel, and a lock actuator mechanism disposed within the casing; and
a base member adapted to be secured to an inner surface of the container body and disposed adjacent to the front panel of the casing;
the base member including a hollow base plate formed with a locking groove at a top edge thereof;
the lock actuator mechanism including:
a tip-over sensor configured to determine whether the residential dumpster being tipped for dumping or knocked over;
a latch lever pivotally disposed within the casing;
a cam shaft extending through the front panel and though the locking groove of the base plate, the cam shaft rotatable relative to the front panel of the casing and the base plate, the latch lever non-rotatably attached to the cam shaft and pivotally mounted to the front panel of the casing;
a locking cam non-moveably attached to the cam shaft so as to extend though the locking groove in the base plate;
a pivot lever pivotable relative to the casing; and
a support member fixed to the pivot lever such that a distal end of the latch lever is configured to engage the support member.

2. The locking device as defined in claim 1, wherein the locking cam is pivotally movable between a locked position preventing the movement of the locking cam out of the locking groove so as to prevent relative movement between the casing of the base lock unit and the base plate, and a release position permitting the movement of the locking cam out of the locking groove so as to permit relative movement between the casing of the base lock unit and the base plate.

3. The locking device as defined in claim 1, wherein the latch is biased by a biasing spring against the support member.

4. The locking device as defined in claim 1, wherein the distal end of the latch lever has a support wheel configured to engage the support member.

5. The locking device as defined in claim 1, wherein the base member further includes a pawl formed with a pawl hook, wherein the pawl is pivotable between a closed position wherein the pawl hook protrudes into the locking groove of the base plate and an open position wherein the pawl hook stands out of the locking groove, wherein the pawl is biased toward the closed position thereof, and wherein a pawl biasing spring mounted within the hollow base plate for biasing the pawl toward the closed position thereof.

6. The locking device as defined in claim 1, further comprising a lock operator adapted to be secured to an outer surface of the container body and to the base plate so that the base member is disposed between the lock operator and the front panel of the casing.

7. The locking device as defined in claim 6, wherein the lock operator includes a key-operated cylinder lock extending between the rotary knob and the base plate.

8. The locking device as defined in claim 1, wherein the pivot lever is pivotable about a pivot axle secured to the casing.

9. The locking device as defined in claim 8, wherein the pivot lever has a hollow oval casing attached to an end of the pivot lever opposite to the pivot axle, and a weight disposed inside the hollow oval casing and is moveable within the hollow oval casing by gravity.

10. The locking device as defined in claim 9, wherein the weight is in the form of a cylinder or a ball.

11. The locking device as defined in claim 9, wherein the lock actuator mechanism further includes a curved guide track secured to the front panel of the casing for guiding the pivot lever.

12. The locking device as defined in claim 9, wherein the tip-over sensor acting as a pivot lever limiter secured to the front panel of the casing for controlling the pivotal movement of the pivot lever.

13. The locking device as defined in claim 12, wherein the pivot lever limiter comprises a housing forming a first chamber and a second chamber, and wherein the first chamber contains a first ball, while the second chamber contains a second ball.

14. The locking device as defined in claim 1, wherein the lock actuator mechanism further comprises one or more electrical batteries, and a servomotor configured to selectively rotate the pivot lever.

15. The locking device as defined in claim 14, further comprising:
a camera to sense accumulation of trash and other materials in container body; and
a printed circuit board (PCB) including a controller operatively connected to at least one of the servomotor, the camera and the tip-over sensor;
the locking device responsive to the container being lifted up and tipped over, which is sensed by the tip-over sensor, which signals the controller to actuate the servomotor, which, in turn, rotates the pivot lever and causes the pivot lever to pivot out of engagement with the latch lever, which pivots to rotate the locking cam in the locking groove of the base plate to the unlocked position;
the locking device responsive to the container being fallen over, which is sensed by the tip-over sensor, which does not send a signal the controller to activate the servomotor to rotate the pivot lever to pivot out of engagement with the latch lever so as to maintain the locking cam in the locked position, and prevent the locking mechanism from moving into the unlocked position in which lid remains closed and locked.

16. The locking device as defined in claim 15, wherein the one or more electrical batteries are electrically connected to the servomotor, the camera, the tip-over sensor and the PCB.

17. The locking device as defined in claim 16, wherein the tip-over sensor is an accelerometer sensing an impact.

18. A residential dumpster liftable and tippable over by a dumping vehicle between an upright position and a tilted position sufficient to enable at least some of the contents of said container to be dumped therefrom, the residential dumpster comprising:
a container body;
a hinged lid pivotally mounted to the container body, the hinged lid moveable between a closed position when the container is in the upright position and an open position when the container is in the tilted position; and
a locking device comprising:
a base lock unit adapted to be mounted to the lid, the base lock unit including a casing having a front panel, and a lock actuator mechanism disposed within the casing; and
a base member secured to an inner surface of the container body and disposed adjacent to the front panel of the casing;
the base member including a hollow base plate formed with a U-shaped locking groove at a top edge thereof, and includes therewithin a pawl formed with a pawl hook, the pawl pivotable between a closed position wherein the pawl hook protrudes into the locking groove of the base plate and an open position wherein the pawl hook stands out of the locking groove, the pawl biased toward the closed position thereof;
the lock actuator mechanism including:
a tip-over sensor configured to determine whether the residential dumpster being tipped for dumping or knocked over;
a latch lever pivotally disposed within the casing;
a cam shaft extending through the front panel and though the locking groove of the base plate, the cam shaft rotatable relative to the front panel of the casing and the base plate, the latch lever non-rotatably attached to the cam shaft and pivotally mounted to the front panel of the casing;
a locking cam non-moveably attached to the cam shaft so as to extend though the locking groove in the base plate;
a pivot lever pivotable relative to the casing; and
a support member fixed to the pivot lever such that a distal end of the latch lever is configured to engage the support member.

19. The residential dumpster as defined in claim 18, further comprising a lock operator adapted to be secured to an outer surface of the container body and to the base plate so that the base member is disposed between the lock operator and the front panel of the casing.

20. The residential dumpster as defined in claim 19, wherein the lock operator includes a key-operated cylinder lock extending between the rotary knob and the base plate.

21. A locking device for a residential dumpster having a container body and a hinged lid pivotally connected to the container body, the locking device comprising:
a base lock unit adapted to be mounted to the lid, the base lock unit including a casing having a front panel, and a lock actuator mechanism disposed within the casing; and
a base member adapted to be secured to an inner surface of the container body and disposed adjacent to the front panel of the casing;
the base member including a hollow base plate formed with a locking groove at a top edge thereof;
the lock actuator mechanism including:
a tip-over sensor configured to determine whether the residential dumpster being tipped for dumping or knocked over, the tip-over sensor comprises a housing forming a first chamber and a second chamber, and wherein the first chamber contains a first ball, while the second chamber contains a second ball;
a latch lever pivotally disposed within the casing;
a cam shaft extending through the front panel and though the locking groove of the base plate, the cam shaft rotatable relative to the front panel of the casing and the base plate, the latch lever non-rotatably attached to the cam shaft and pivotally mounted to the front panel of the casing;
a locking cam non-moveably attached to the cam shaft so as to extend though the locking groove in the base plate;
a pivot lever pivotable relative to the casing; and
a support member fixed to the pivot lever such that a distal end of the latch lever is configured to engage the support member.
